(19) United States
(12) Patent Application Publication
(10) Pub. No.: US 2015/0006349 A1
(43) Pub. Date: Jan. 1, 2015

(54) Electronic Trading Auction With Orders Interpreted Using Future Information

(71) Applicant: D. E. Shaw & Co., L.P., New York, NY (US)

(72) Inventors: Jonathan David Eddy, New York, NY (US); Thomas Barnet-Lamb, Chicago, IL (US)

(21) Appl. No.: 13/930,843

(22) Filed: Jun. 28, 2013

(51) Int. Cl. G06Q 40/04

(52) U.S. Cl. CPC G06Q 40/04
USPC 705/37

(57) ABSTRACT

Exemplary embodiments are related to processing electronic trading orders in an electronic trading exchange environment. Electronic trading orders can be accepted from auction participants' electronic devices in a first time period of an electronic auction. A random time delay can be applied in response to expiration of the first time period and the electronic trading orders can be randomly sorted to generate one or more order queues. The electronic trading orders can be matched based on a randomized sequence of electronic orders defined by such order queues. In exemplary embodiments, the electronic trading environment can accept parameterized orders having one or more unspecified parameters. The parameterized orders can be transformed into concrete orders after the parameterized orders are accepted using future information ascertained at some randomized time after the first time period has expired.

### BACKGROUND

Electronic trading exchanges provide a marketplace for the purchase and sale of financial instruments, such as securities, commodities, futures, exchange traded funds (ETFs), mutual funds, and options. Conventionally, these exchanges allow market participants to submit electronic trading orders for execution by a matching engine implemented by the exchange. As a result, most exchanges no longer require human interaction on a “trading floor” to execute a trade transaction. The matching engines implemented by the conventional exchanges can use matching or crossing algorithms to match sell orders with buy orders based on the parameters specified in such orders.

Conventional electronic exchanges can benefit those investors that submit electronic trading orders earlier in a continuous-auction-based exchange because the electronic trading orders are typically submitted to the matching engine based on when the orders were received. As a result, the first investor to act may have the first opportunity to be matched with resting orders, and those resting orders may not yet have incorporated the most recent news and market information. In this manner, the trader with the lowest latency (i.e., delay) may have an advantage over those traders with higher latency on the conventional exchange; put another way, a faster trader may have an advantage over a slower trader. Likewise, conventional electronic exchanges can benefit those investors that submit electronic trading instructions later because these investors may have access to more information than the earlier traders, including, for example, knowledge of the parameters of placement orders (e.g., quantity and price) that were already submitted.

The advent of electronic trading exchanges has resulted in some market participants using sophisticated automated trading systems to take advantage of the above order submission strategies. These automated trading systems provide electronic platforms that allow market participants to use algorithms to automatically submit electronic trading orders with minimal or no human intervention. These trading systems are commonly used by institutional investors, mutual funds, broker-dealers, and hedge funds.

In some instances, investors use automated trading systems to implement high-frequency trading (HFT) strategies and/or low-latency strategies to programmatically initiate electronic trading orders. HFT strategies utilized by investors can generate electronic trading orders based on information received electronically, often times before conventional traders can process the information. HFT strategies typically buy a quantity of a financial instrument and quickly sell the quantity of the financial instrument within minutes or seconds. Investors that use these HFT strategies can perform many of these transactions in one trading period (e.g., a trading day) and the quantities of the financial instruments bought and sold are typically large (e.g., 100,000 or more shares of a stock).

Low-latency trading strategies utilized by investors to submit electronic trading orders seek to minimize any latencies in submitting electronic trading orders and typically submit trades within microseconds. Low-latency trading strategies use ultra-low latency networks and/or have co-located trading platforms in the same facilities as the exchange systems to benefit from implementing high-frequency trading strategies to achieve faster execution times compared to other investors having higher latency systems.

The recognized advantages of low-latency platforms has led to a low-latency “arms race” in which many investors are continuously deploying new technology to realize lower latency to maintain or establish an advantage over other investors. Such low-latency platforms can be expensive to develop and maintain. This can lead to substantial costs in hardware and software to maintain an advantage. As a result, investors typically expend resources and money to ensure no one has an advantage over them, but once investors have invested in lower latency systems they may each be no better off than they would have been without the investments; indeed, they may be worse off because of the substantial investment expenditures.

### SUMMARY

The present disclosure relates to an electronic trading exchange in which orders can be interpreted using information, and methods and computer-readable media relating thereto. Exemplary embodiments advantageously provide a technical solution to reduce incentives that drive market participants to invest in ultra-low-latency infrastructure. While efficient markets have universal benefit, present conditions provide out-sized rewards to market participants that invest in the next microsecond of reduced latency. Exemplary embodiments of the present disclosure seek to curtail the “low-latency arms race” by reducing the impact of low latency trading platforms using a technical solution that limits the usefulness of low latency platforms such that investment in low latency platforms no longer offers a competitive advantage to investors.

In one embodiment, a method of implementing an electronic trading exchange is provided. The method includes accepting electronic trading orders from auction participants' electronic devices in a first time period of an electronic auction, applying a random time delay in response to expiration of the first time period, executing code to randomly sort the electronic trading orders to generate one or more order queues, and programmatically matching the electronic trading orders based on a randomized sequence of electronic orders defined by the one or more order queues.

In another embodiment, a non-transitory, computer-readable medium storing instruction executable by a processing device in an electronic trading exchange environment is provided. Execution of the instructions by the processing device causes processing of electronic trading orders in the electronic trading exchange environment, the processing including accepting electronic trading orders from auction participants' electronic devices in a first time period of an electronic auction, applying a random time delay in response to expiration of the first time period, executing code to randomly sort the electronic trading orders to generate one or more order queues, and programmatically matching the electronic trading orders based on a randomized sequence of electronic orders defined by the one or more order queues.

In yet another embodiment, a system of processing electronic trading instructions in an electronic trading exchange environment is provided. The system includes at least one storage device and a processing device communicatively coupled to the at least one storage device. The at least one storage device stores instructions for an order handling process. The processing device is programmed to execute the instructions to accept electronic trading orders from auction participants' electronic devices in a first time period of an electronic auction, apply a random time delay in response to expiration of the first time period, execute code to randomly sort the electronic trading orders to generate one or more order queues, and match the electronic trading orders based on a randomized sequence of electronic orders defined by the one or more order queues.

In some embodiments, the code to randomly sort the electronic trading orders can be executed to programmatically group the electronic trading orders for a price level based on participant identifiers associated with the electronic trading orders within the price level subsequent to an expiration of a second time period and to randomly sort the groups electronic trading orders within the price level to generate a price level order queue.

In some embodiments, the electronic trading orders can be programmatically matched based on the price level and a randomized sequence of electronic orders defined by the price level order queue.

In some embodiments, the electronic trading orders can be accepted as parameterized orders having one or more order parameters to be determined subsequent to acceptance and/or as concrete orders having parameters specified prior to acceptance. The parameterized orders can be transformed into concrete orders, for example, based on information ascertained after the expiration of the second time period and prior to randomly sorting groups of electronic trading orders.

In some embodiments, a sequence of auctions can be implemented and a different random time period can be specified for the auctions.

Exemplary embodiments of the present disclosure advantageously overcome issues associated with accepting electronic trading orders earlier and/or later from auction participants. For example, exemplary embodiments can advantageously generate a randomized ordering of electronic trading orders to mitigate benefits of submitting electronic trading orders early in the acceptance phase. Likewise, exemplary embodiments can advantageously mitigate any information advantage that would conventionally be bestowed upon auction participants that submit their electronic trading orders later than other auction participants by the randomized ordering of instructions. Furthermore, exemplary embodiments advantageously allow auction participants to submit parameterized orders that can be transformed into concrete orders based on common information (e.g., the same information can be applied to all parameterized orders). Allowing auction participants to submit parameterized orders allows new information that arrives between submission of the parameterized orders and matching of the electronic trading order in the order book to be incorporated into the parameterized orders prior to delivering the electronic trading orders to a matching engine. Using this approach the need for market participants to race to revise their orders in response to market-changing information is mitigated, since all orders will be automatically interpreted and matched with respect to a common set of future information. This reduces expense and technical complexity for market participants.

Any combination or permutation of embodiments is envisioned. Other objects, features, and/or advantages will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

FIG. 1 is a block diagram of an exemplary exchange engine in accordance with exemplary embodiments of the present disclosure.

FIG. 2 is a block diagram of an electronic trading exchange environment in accordance with exemplary embodiments of the present disclosure.

FIG. 3 is a flowchart of an exemplary order handling process implemented by embodiments of the exchange engine.

FIG. 4 is a flowchart of an exemplary order transformation process implemented by embodiments of the exchange engine.

FIG. 5 is a flowchart of an exemplary process implemented by embodiments of the exchange engine to dynamically generate price levels and associate electronic trading orders with price levels.

FIG. 6 is a flowchart showing an overview of one exemplary process for grouping electronic trading orders.

FIG. 7 is a flowchart of an exemplary embodiment of an electronic trading order sorting process implemented by an exemplary embodiment of the exchange engine.

FIG. 8 is a block diagram of an exemplary computing device for implementing embodiments of the exchange auction engine in accordance with exemplary embodiments of the present disclosure.

FIG. 9 is a block diagram of a distributed electronic trading exchange environment in accordance with exemplary embodiments of the present disclosure.

### DESCRIPTION OF EXEMPLARY EMBODIMENTS

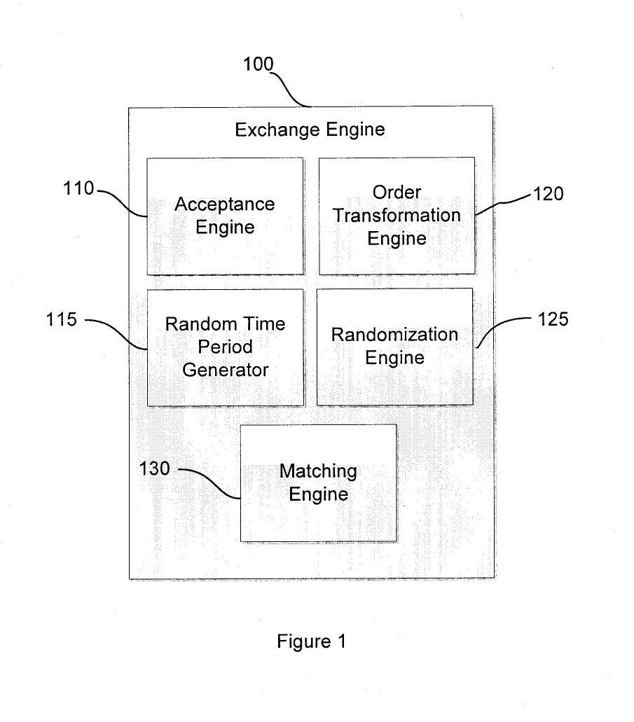

Exemplary embodiments of the present disclosure are related to processing electronic trading orders in an auction-based electronic trading exchange environment, as described with respect to FIGS. 1-9. In exemplary embodiments, auction participants' electronic devices can be in communication with one or more computing devices executing an exchange engine, or portions thereof. The exchange engine can be programmed to allow auction participants to submit electronic trading orders for consideration in one or more electronic trading auctions implemented by the exchange engine. The exchange engine can be programmed to implement the electronic trading auctions in parallel and/or in sequence.

Exemplary embodiments of the exchange engine can be programmed to receive concrete and/or parameterized electronic trading orders from the auction participants' electronic devices during an acceptance phase of an auction and can terminate the acceptance phase after expiration of a first time period. Upon expiration of the first time period, a second time period defined by a random time delay can be applied. Once the second time period expires, parameterized electronic trading orders can be transformed into concrete electronic trading orders based on information ascertained by the exchange engine. By applying a random time delay before transforming parameterized orders into concrete orders, exemplary embodiments of the exchange engine can reduce and/or eliminate the ability of auction participants to anticipate the timing of a parameterized order transformation which may mitigate the possibility of manipulating the external information that might be used to transform parameterized orders into concrete orders.

In exemplary embodiments, the electronic trading orders accepted by the exchange engine can be associated with corresponding price levels and the electronic trading orders for each price level can be grouped based on participant identifiers. By grouping the electronic trading order by auction participant, exemplary embodiments of the present disclosure advantageously reduces and/or eliminates an incentive for an auction participant to submit a multitude of orders in a short period of time in an attempt to increase such auction participant's chances of having an order at the front of the order queue because all of such auction participant's orders will be grouped together. The groups of electronic trading orders in each price level can be randomly sorted to generate price level order queues having random ordering of the groups of electronic trading orders.

After the groups of electronic trading orders are randomly sorted for each price level, exemplary embodiments of the present disclosure can submit the orders to a matching engine based on the price level and price level order queues and the matching engine can match orders based on a priority determined, at least in part, by a randomly determined position of the groups of electronic trading orders in the price level order queues. By randomly sorting the grouped electronic trading orders and submitting the groups of random trading orders to the matching engine according to their position in the randomly generated price level order queue, exemplary embodiments of the present disclosure advantageously reduce and/or eliminate any advantages auction participants would have realized by submitting their electronic trading orders early in the acceptance phase.

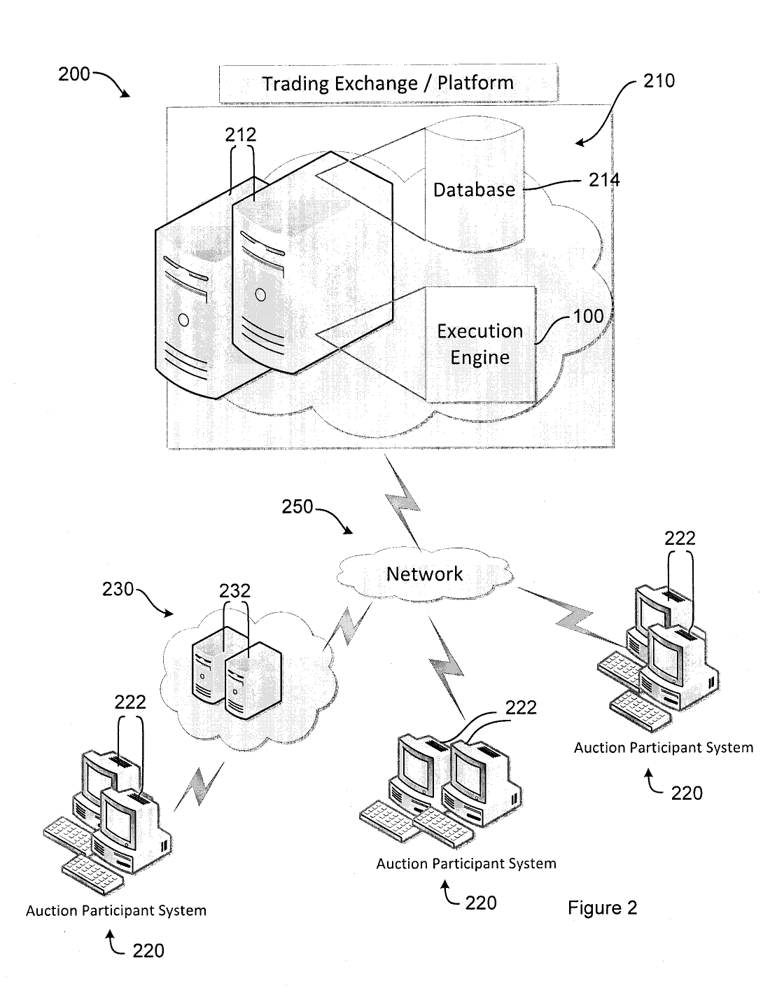

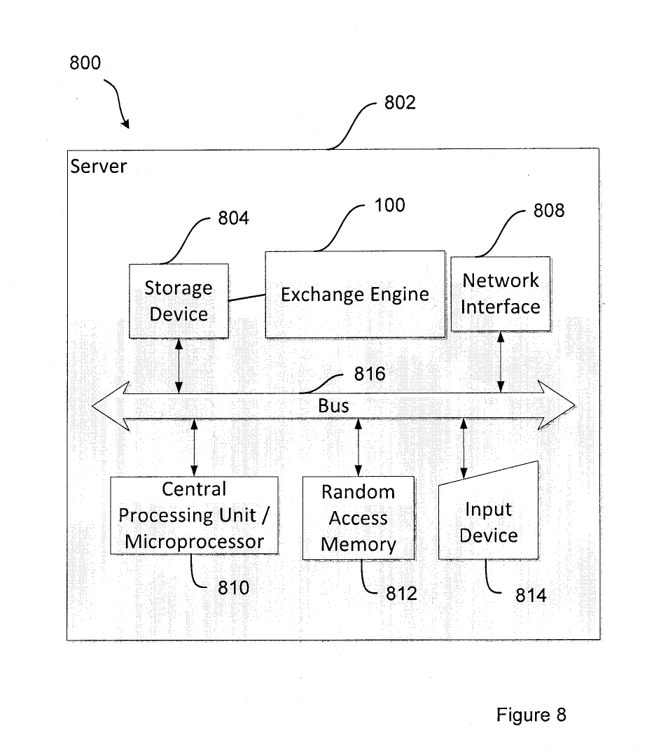

FIG. 1 is a block diagram of an exemplary exchange engine 100. Exemplary embodiments of the engine 100 can be implemented using hardware, software, and/or a combination thereof. For example, in one exemplary embodiment, one or more computing devices, such as one or more servers, can be configured to implement exemplary embodiments of the engine 100. An exemplary embodiment of a computing device programmed and/or configured to implement exemplary embodiments of the engine 100 is shown, for example, in FIGS. 2 and 8. The engine 100 can include an acceptance engine 110, a random delay generator 115, an order transformation engine 120, a randomization engine 125, and a matching engine 130. The engine 100 can be programmed and/or include executable code to implement one or more order handling processes to facilitate one or more auction-based transactions.

Exemplary embodiments of the present disclosure can be used to implement periodic call auctions in which electronic trading orders are submitted over a period of time, referred to herein as the acceptance phase, after which the electronic trading orders are executed. One example of a call auction is a double auction in which orders to buy and orders to sell a financial instrument are simultaneously submitted to the exchange engine 100 (e.g., operating as an auctioneer), which programmatically chooses a price for the financial instrument that clears the market such that all orders to sell the financial instrument specifying a price that is less than the chosen price for the financial instrument are sold at the chosen price and all orders to buy the financial instrument specifying a price that is greater than the chosen price of the financial instrument buy the financial instrument at the chosen price.

The auctions implemented by the engine 100 can occur in sequence and/or in parallel with each other. In some embodiments, the auction(s) can be completed on the order of seconds, minutes, hours, and so on. In one exemplary embodiment, the engine 100 can implement a sequence of temporally consecutive auctions during a trading period (e.g., a trading day) and each auction can be completed in a few seconds or minutes.

Exemplary embodiments of the engine 100 can be implemented as a stand-alone exchange and/or can be incorporated/implemented as part of another exchange, such as the NASDAQ, NYSE, Chicago Board of Options Exchange, Chicago Board of Trade, Chicago Mercantile Exchange, London Stock Exchange, Deutsche Borse, Tokyo Stock Exchange, Mercantile Exchange, New York Mercantile Exchange, Eurex, LIFFE and/or any other exchanges. The acceptance engine 110 can be programmed and/or configured to receive, accept, and maintain electronic trading orders from participants of an electronic auction (i.e., auction participants). The acceptance engine 110 can be programmed and/or configured to accept different types of electronic trading orders, including, for example, a buy order, a sell order, a put order, a call order, and/or any other suitable electronic trading order. The acceptance engine 110 can also be programmed and/or configured to receive, accept, and maintain cancel requests associated with one or more previously submitted electronic trading orders. In one exemplary embodiment, the electronic trading orders accepted by the engine 110 can be placement orders for selling/buying financial instruments, such as stocks, bonds, commodities, futures, ETFs, mutual funds, options, currencies, swaps, and/or any other suitable items that may be traded in an exchange market. The electronic trading orders accepted during the acceptance phase form an auction order book (e.g., a collection of all orders in an auction to be considered for execution by the engine 100). In some embodiments, the acceptance engine 110 can be programmed to notify auction participants that an acceptance phase is open (or will be beginning) and that the participants can begin placing electronic trading orders when the acceptance phase is open.

The acceptance engine 110 can be programmed and/or configured to terminate the acceptance phase after an acceptance time period expires and/or after the auction participants have entered their electronic trading orders. As an example, in one embodiment, the acceptance engine 110 can be configured to close the acceptance phase after a specified amount of time has lapsed from when the acceptance phase was initiated. As another example, in one embodiment, the acceptance engine 110 can be programmed and/or configured to request final orders to be entered before closing the acceptance phase to provide participants an opportunity to enter their electronic trading orders for consideration in the pending auction.

The electronic trading orders received from the auction participants, via the auction participants' electronic devices, can include order parameters that can be used by the engine 100 when determining how to process the electronic trading orders. Some examples of order parameters that can be included in the electronic trading orders include a price parameter, a duration parameter, a quantity (or size) parameter, an order type parameter, a participant identifier, and/or any other suitable parameters that can be used by the engine 100 when processing the electronic trading orders. The price parameter identifies a price at which the auction participant will buy or sell the financial instrument (e.g., a dollar amount or market price). The duration parameter identifies a time period over which the trading order will be valid (e.g., guaranteed until cancelled, one day, one week, one auction cycle, etc.). The quantity parameter identifies a quantity of the financial instruments the auction participant wishes to buy or sell (e.g., order size, such as 100 shares of a stock). The instruction type parameter identifies the type of trading instruction being submitted by the auction participant (e.g., a market order, a limit order, a buy order, a sell order, cancel requests and/or any other order types). In an exemplary embodiment, a market order to buy a financial instrument is processed by the engine 100 as a limit order to buy the financial instrument at an infinite price and a market order to sell a financial instrument is processed by the engine 100 as a limit order to sell the financial instrument at a price of zero. The limit orders at a price of zero and infinity generally are not executed at these prices due to the call auction matching priority rules described herein. The participant identifier provides an identity of the auction participant that is submitting the electronic trading order. In exemplary embodiments, the participant identifier can be, for example, a username, an account number, an IP address, a MAC address, a business name, a string of alphanumeric character, and/or any other suitable identifiers that can be used to distinguish between different auction participants.

In exemplary embodiments, the acceptance engine 110 can be programmed and/or configured to receive, accept, and maintain concrete electronic trading orders and parameterized electronic trading orders from the auction participants. A concrete electronic trading order can specify order parameters at the time the order is entered by an auction participant, such that the order can be executed by the matching engine in its received form. A parameterized electronic trading order can specify some order parameters at the time the order is entered by the auction participant, but can include some parameters that are specified by the engine 100 after the order is accepted by the engine 100. In some embodiments, the auction participants can specify how they would like the unspecified parameters to be specified.

As one example, in one embodiment, a parameterized order can be submitted by an auction participant that does not specify a price for the financial instrument to be bought or sold and/or an order size (i.e., quantity of a financial instrument to be bought or sold). For example, an auction participant may submit an electronic trading order that does not specify a specific price value for the financial instrument, does not specify a specific quantity of the financial instrument, or does not specify a specific value for either the price parameter or the order quantity parameter. In some embodiments, a parameterized order can be submitted by an auction participant that includes a conditional function such that one or more order parameters depend on whether a condition is satisfied. The acceptance engine 110 can accept the parameterized electronic trading order without a specified order parameter and the engine 100 can specify the order parameter upon expiration of a random delay applied to the end of the acceptance phase. To indicate how the auction participant would like the engine 100 to specify the order parameter, the auction participant can include one or more parameter codes and/or processing instructions in the electronic trading order. In exemplary embodiments, electronic trading instructions with unspecified parameters (i.e., parameterized orders) can be specified by the engine 110 at the same time and/or with respect to the same information. By specifying the parameter(s) at the same time and/or with the same information, the engine 100 can prevent discrepancies between parameterized orders that would give one auction participant an advantage over another auction participant.

A parameterized order for which the engine 100 specifies the value for the price parameter after an auction participant submits the parameterized order can include a price code and/or processing instructions, referred to herein as price specification instructions, that instructs the engine 100 how to specify the value of the price parameter. The engine 100 can specify the price parameter at a randomly determined time subsequent to the acceptance of the parameterized order. In exemplary embodiments, an auction participant can instruct the engine 100 to specify the value of the price parameter for a financial instrument using, for example, one or more of the following price specification instructions:
A bid or ask price of the financial instrument in the National Best Bid Offer (NBBO). For example, in some embodiments, the auction participant may want the engine 100 to use the NBBO price when specifying the price and can enter “NBBO Bid” or “NBBO Ask” for the price parameter in the parameterized electronic trading order. After the engine 100 ascertains the NBBO price the engine can use the NBBO price to specify the price parameter.
A bid or ask price of the financial instrument, such as a stock or a future, at a particular level of an order book on another specified exchange.
A price of a financial instrument for the last execution (e.g., trade) of the financial instrument. In some embodiments this price can be restricted to a specified exchange.
A volume-weighted average price, or any other suitable price statistic, for executions (e.g., trades) of the financial instrument over a specified window of time. In some embodiments this price can be restricted to a specified exchange.
A time-weighted average price (or any other price statistic) for executions (e.g., trades) of the financial instrument over a specified window of time. In some embodiments this price can be restricted to a specified exchange.
An opening price of the financial instrument on a specified exchange.
A closing price of the financial instrument on a specified exchange.
A highest bid price or lowest ask price from an order book on another specified exchange. In some embodiments, the highest bid price or lowest ask price can be restricted to an order in the order book that has at least a specified minimum order size (i.e., quantity of the financial instrument to be bought or sold)
A highest bid price from an order book for some financial instrument on another specified exchange for which the order size in the order book summed from this level (i.e. the highest bid price) up to the inside level is at least a certain ‘size’ (number of units (i.e., the quantity) of the financial instrument in question), which size will be specified in the order codes and processing instructions associated with the order with the yet-to-be-specified price. If so instructed, at the time the engine 100 specifies the price parameter of the order in question, the engine 100 examines a feed of data from the other specified exchange which can be used to reconstruct the order book of resting orders to buy the financial instrument in question on the other exchange. Having reconstructed the order book, the buy orders can be listed: there are resting orders to buy up to quantity Q1 at price P1, a further quantity Q2 at price P2<P1, a further quantity Q3 at price P3<P2, and so on up to a quantity Qn at price Pn<P(n−1). The engine 100 determines the lowest n such that Q1+Q2+ . . . +Qn exceeds the size specified in the order codes and processing instructions. Using the above, the price is specified by the engine 100 as Pn. If no such n exists, the order is cancelled by the engine 100.
A lowest ask price from an order book for some financial instrument on another specified exchange for which the order size in the order book summed from this level (i.e., the lowest ask price) down to the inside level is at least a certain ‘size’ (number of units (i.e., the quantity) of the financial instrument in question), which size will be specified in the order codes and processing instructions associated with the order with yet-to-be-specified price. If so instructed, at the time the engine 100 specifies the price parameter of the order in question, the engine 100 examines a feed of data from the other specified exchange which can be used to reconstruct the order book of resting orders to sell the instrument in question on the other exchange. Having reconstructed the order book, the sell orders can be listed: there are resting orders to sell up to quantity Q1 at price P1, a further quantity Q2 at price P2>P1, a further quantity Q3 at price P3>P2, and so on up to a quantity Qn at price Pn>P(n−1). The engine 100 determines the lowest n such that Q1+Q2+ . . . +Qn exceeds the size specified in the order codes and processing instructions. Using the above, the price is specified by the engine as Pn. If no such n exists, the order is cancelled by the engine 100.
An offset relative to one of a price determined based on one of the above or below identified price values. As one example, an electronic trading order can specify the price parameter as the opening price for the financial instrument on another exchange plus a percentage or specific value (e.g., if the opening price is $10.00, the electronic order can specify the opening price plus $2.50, such that the engine 100 can specify the price parameter for the electronic trading order to be $12.50)
A maximum (or minimum) of a list of prices. For example, in one embodiment, a list of prices can be a list of prices generated using one or more of the other price-specification-instructions described herein and the engine 100 can select the maximum (or minimum) price from the list of prices and can specify the price parameter for the parameterized order using the selected price.
A weighted sum of a list of prices with the weights specified for the prices in the list. In some embodiments, the weights specified for the prices in the list can be negative to obtain a difference between prices. In some embodiments, the weights can be the basket weights corresponding to an index (e.g., the S&P 500), which is formed by an aggregate of individual financial instruments. The basket weights can be derived from market capitalization of the financial instruments in the index, market-share of the financial instruments in the index, a price of the financial instruments in the index, and/or any other suitable parameters that can be used to generate weighted values. In one exemplary embodiment, the list of prices can be a list of prices generated using one or more of the other price-specification-instructions described herein and each price in the list of prices can be weighted.
A price of a financial instrument converted from one currency to another. In some embodiments, the currency price is itself a price specifiable based on price specification instructions as described herein.

A parameterized order for which the engine 100 specifies the value for the quantity parameter (i.e., order size) after an auction participant submits the parameterized order can include a quantity code and/or processing instructions, referred to herein as size specification instructions, that instructs the engine 100 how to specify the value of the price parameter. The engine 100 can specify the quantity parameter at a randomly determined time subsequent to the acceptance of the parameterized order. In exemplary embodiments, an auction participant can instruct the engine 100 to specify the value of the quantity parameter using, for example, one or more of the following size specification instructions:
A linear function of price. As one example, in one embodiment, the value Q of the quantity parameter can be determined using the following mathematical expression:

Q=(C1−Price)*C2/C3,
where C1 and C3 have units of dollars, C2 has units of shares, and Price is the price of the financial instrument in dollars. For example, if C1=40, C2=100, C3=0.01, and Price=30, then the value Q of the quantity parameter specified by the engine 100 is 100,000 shares.
A minimum or maximum of volumes, e.g., min(X shares, max(0,(Y dollars−Price)*100 shares/(0.01 dollars))), wherein the quantity of shares used to specify the quantity parameter of a parameterized order can be X shares or the maximum of zero shares or the quantity of shares determined by the mathematical expression (Y dollars−Price)*100 shares/(0.01 dollars). For example if X equals 1000 shares, Y equals 40 dollars, and Price equals 40.05 dollars, then order size parameter is specified as min(1000 shares, max(0, −500 shares))=0 shares.
A sum of volumes and/or other suitable functions of volumes, such as the geometric mean of two other volumes, the average of two other volumes, and/or any another suitable statistical, historic, or projected functions of volume.
A fraction of the quantity (e.g., shares) traded in a financial instrument (e.g., a security, such as a stock) over a particular time window. In some embodiments, the quantity is restricted to a specified exchange.
A quantity of the financial instrument at a particular price or over a range of prices in the order book.

A parameterized order for which the engine 100 specifies one or more order parameters based on whether a condition is satisfied (i.e., a conditional function) after an auction participant submits the parameterized order can include one or more parameter codes and/or processing instructions that instructs the engine 100 how to specify the value of the one or more order parameters. One example of a structure for a conditional function can be provided as follows:

if <condition> then <A> else <B>,

where “A” is performed by the engine 100 if the condition is satisfied and “B” is performed by the engine 100 if the condition is not satisfied. The operations specified A and B can include, for example, instructions to buy/sell a quantity of a financial instrument. In exemplary embodiments, auction participants can implement a conditional function as a way to select which of a set of securities to trade. For example, if an auction participant was willing to buy any one of three ETFs on the S&P 500, a conditional function can be used to select the one with the lowest price to transform the parameterized order into a concrete order. In some embodiments, auction participants can use conditional functions to cancel an electronic trading order if something abnormal/unexpected/undesirable occurred with respect to the order. For example, an auction participant can generate a parameterized order using a conditional function that cancels the parameterized order if the price of the financial instrument has moved too much, a news ticker tape contains certain key words, an announcement value is above or below a certain number, and/or if any other abnormal/unexpected/undesirable events occurred before the engine 100 transforms the parameterized order into a concrete order.

The random delay generator 115 can be programmed to specify a random time delay that is applied in response to the termination of the acceptance phase. In some embodiments, the random delay generator 115 can implement a pseudo-random delay generator, which can be executed for each auction implemented during a trading period, such that the random time delay can be determined each time an auction is run. The random time delay generated by the generator 115 can be unknown to the auction participants so that the auction participants have no knowledge of the length of the random time delay. The random time delay can be determined by the random delay generator 115 prior to, during, or after the acceptance order phase.

The order transformation engine 120 can be programmed and/or configured to transform parameterized electronic trading orders received, accepted, and maintained during the acceptance phase into concrete electronic trading orders by programmatically specifying order parameters that were not specified at the time the order was entered by the participants. In exemplary embodiments, the order transformation engine 120 can use information received from one or more data sources external to the engine 100 and/or can use information generated by the engine 100. As one example, the engine 120 can be configured to receive information for the financial instrument being auctioned. The information can be, for example, the NBBO ask and/or bid price for the financial instrument or other financial instruments, the best bid and offer on particular exchanges, order-book information from other exchanges, and other information that can be used to specify unspecified parameters of parameterized orders. In exemplary embodiments, the engine 120 can be programmed and/or configured to apply this information to the unspecified parameters of a parameterized electronic trading order to specify the price in the parameterized electronic trading order.

In exemplary embodiments, the order transformation engine 120 can be programmed to ascertain the information used to transform the parameterized electronic trading order to a concrete electronic trading order after the random time delay expires. In some embodiments, the information ascertained can be time-dependent. For example, when the order transformation engine 120 uses information from a source external to the engine 100, the information can change dynamically over time such that the information used by the engine to transform the electronic trading orders can vary based on when the engine 120 transforms the electronic trading order. For example, for embodiments in which the NBBO price is used to specify a price in a parameterized electronic trading order, the NBBO price can be ascertained by the order transformation engine 120 after the random time delay applied in response to the termination of the acceptance phase expires.

The randomization engine 125 can be programmed and/or configured to sort the electronic trading orders. In one embodiment, the electronic trading orders can be grouped programmatically based on the price parameter specified in the electronic trading orders to identify price levels. In this process, infinity and zero can be counted as price levels, which can arise, for example, from the treatment of market orders described herein. For example, electronic trading orders having an identical price value for the price parameter can programmatically be grouped or electronic trading orders having a price value for the price parameter that correspond to a range of prices can be programmatically grouped.

After the electronic trading orders are grouped into the price levels, the randomization engine 125 can be programmed and/or configured to group the electronic trading orders in each price level based on the participant identifier so that electronic orders at each price level are grouped according to the auction participant submitting the electronic trading orders. For example, electronic trading orders in a price level that are associated with an identical auction participant identifier can programmatically be grouped within the price level. The randomization engine 125 can be programmed and/or configured to randomly sort the grouped electronic trading orders for each price level to define an order queue for each price level. The random sorting applied by the engine 125 randomly determines a position of the auction participants' groups of electronic trading orders in the order queues for each price level.

The matching engine 130 can be programmed and/or configured to receive the grouped orders in a sequence defined by the price level order queues as determined based on the random sorting by the randomization engine 125. In exemplary embodiments, the auction implemented by the matching engine 130 can be a call auction and the matching engine 130 can determine clearing price(s) for the auction. The matching engine 130 programmatically attempts to match the received electronic trading orders for the groups of orders (grouped by auction participant) with other electronic trading orders in the price level order queues based on the price levels and the order sequences within each price level. The matching engine 130 programmatically matches orders with other orders by applying one or more matching priority rules to the electronic trading orders. For example, the matching engine 130 can programmatically match orders based on a price-priority matching algorithm with intra-price priority and/or any other suitable matching algorithm.

The price-priority matching with intra-price priority gives matching priority to electronic trading orders based on an associated price level (e.g., the price specified in the electronic trading orders) and the time at which the electronic trading orders are delivered to the matching engine 130 (not the time at which they were received by the acceptance engine 110), as determined by the random ordering of the groups of electronic trading orders in the price level queues for each price level. For example, the engine 100 can determine a clearing price for the financial instrument being auctioned and can identify price levels satisfying the clearing price. The groups of electronic trading orders in the price level order queues for the price levels satisfying the clearing price can be delivered to the matching engine 130 to match the electronic trading orders according to their order in the price level queues. In exemplary embodiments implementing a call auction, trading orders that satisfy the clearing price are executed at the clearing price. That is, electronic trading orders to buy a financial instrument for which the auction participant indicated a willingness to buy at a price higher than the clearing price can be filled at the clearing price and electronic trading orders to sell the financial instrument for which the auction participant indicated a willingness to sell at a price lower than the clearing price can be filled at the clearing price. The clearing price can be chosen to maximize trading volume in the auction. In some auctions, electronic trading orders to buy and/or sell at the clearing price may or may not be filled. However, it is always the case that either all buys are filled or all sells are filled; it is possible, but rare, for both all buys and all sells to be filled. If there are electronic trading orders to sell that are not filled, the electronic trading orders can be processed so that priority is determined by the time at which electronic trading orders are delivered to the matching engine based on the price level order queue with which the electronic trading orders are associated and their corresponding position in the price level order queues.

When more than one clearing price can satisfy the above constraints, the clearing price can be selected by considering a set S of clearing prices such that, if a clearing price P is selected from the set S, the trading volume attains a maximum value and, subject to this maximum value, the total unmatched/unfilled electronic trading orders is minimized. One example of how this might be done in various cases is as follows: In cases when there is zero unmatched/unfilled electronic trading orders at one (and hence all) of the elements of S, the clearing price is selected at random by the matching engine 130. In another case, if every element of the set S has unmatched sells, the smallest clearing price in the set S is used by the matching engine 130. In yet another case, if every element of the set S has unmatched buys, the largest clearing price in the set S is used by the matching engine 130. As still another example, for other cases not addressed by the programming of the matching engine 130, the matching engine 130 randomly selects between the highest clearing price in the set S with unmatched/unfilled electronic trading orders to buy a financial instrument and the smallest clearing price in the set S with unmatched/unfilled electronic trading orders to sell the financial instrument.

FIG. 2 depicts an exemplary electronic trading exchange environment 200. The environment 200 includes electronic trading exchange platform 210 that includes one or more computing devices configured as servers 212, as well as one or more databases 214, and auction participants' systems 220 that can include, for example, one or more auction participants' electronic devices, which can be computing devices programmed and/or configured to interface with the trading exchange platform 210. The auction participants' systems 220 can be communicatively coupled to the trading exchange platform 210 via a communications network 250. The communication network 250 can be the Internet, an intranet, a virtual private network (VPN), a wide area network (WAN), a local area network (LAN), and the like. The environment 200 can be configured to implement one or more electronic auctions to allow auction participants, via the electronic devices 222, to sell and/or buy financial instruments, such as, for example, stocks, bonds, commodities, futures, ETFs, mutual funds, options, currencies, swaps, and/or any other suitable items that may be traded in an exchange market.

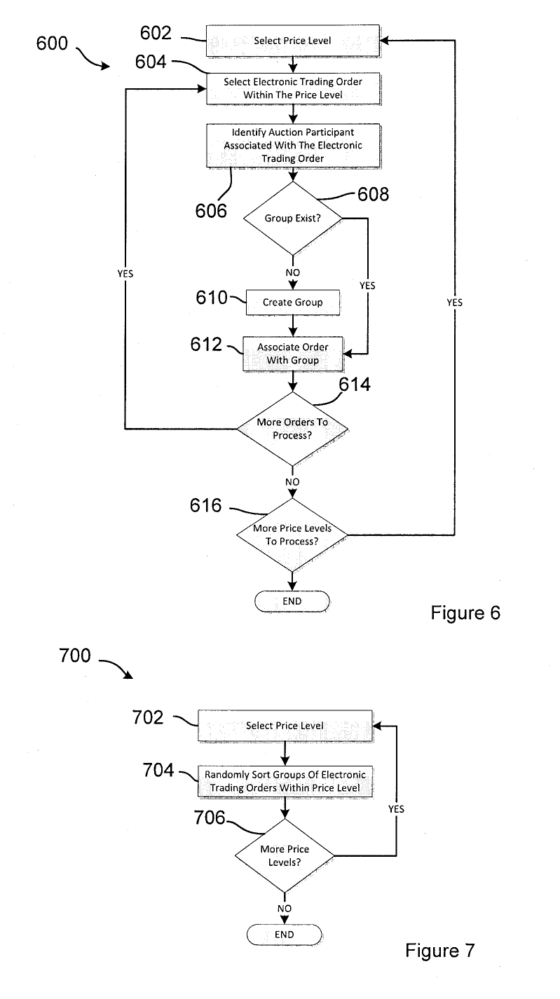

At least one of the servers 212 associated with the electronic trading exchange platform 200 can be programmed to execute an embodiment of the exchange engine 100. An exemplary embodiment of a computing device configured as a server for executing the exchange engine 100 is shown in FIG. 6. In some embodiments, portions of the exchange engine 100 can be distributed across the servers 212, as shown in FIG. 7. Referring to FIG. 2, the one or more databases 214 can store the electronic trading orders received by the electronic trading exchange platform 210, auction information, and/or any other information that can be used to implement exemplary embodiments of the present disclosure. The auction information can include, for example, auction results, auction start times, auction participants, random time delays, pending, and/or subsequent auctions, and/or any other auction information that can be used to implement the auctions in accordance with exemplary embodiments or to maintain a record of auctions previously implemented by the trading exchange platform 200.

In exemplary embodiments, the auction participants' systems 220 can be associated with one or more hedge funds, brokerages, financial institutions, investment banks, institutional investors, trustees, fund managers, individual investors, and/or any other entities that may wish to participate in one or more auctions implemented by trading exchange platform 210. The one or more computing devices configured as electronic devices 222 can be implemented as, for example, a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein. In exemplary embodiments, some of the electronic devices 222 can include a client-side application that is programmed and/or configured to facilitate interaction between the electronic devices 222 and the trading exchange platform 210. In some embodiments, the client-side application can be a web-browser configured to navigate to a web page hosted by the trading exchange platform, which allows the auction participants to submit their electronic trading orders. In some embodiments, the client-side application can be a software application specific to the trading exchange platform 210.

In some embodiments, one of the auction participants' systems 220 can include electronic devices that are programmed and/or configured to interact with an intermediary system 230, which can include one or more servers 232 programmed and/or configured to communicate with the trading exchange platform 210 on behalf of the auction participants' system 220. For example, an auction participant can submit an electronic trading order to the intermediary system 230 via one of the electronic devices 222 and the intermediary system 230 can process and forward the electronic trading order to the trading exchange platform 210. In some embodiments, the intermediary system 230 can be, for example, a broker-dealer.

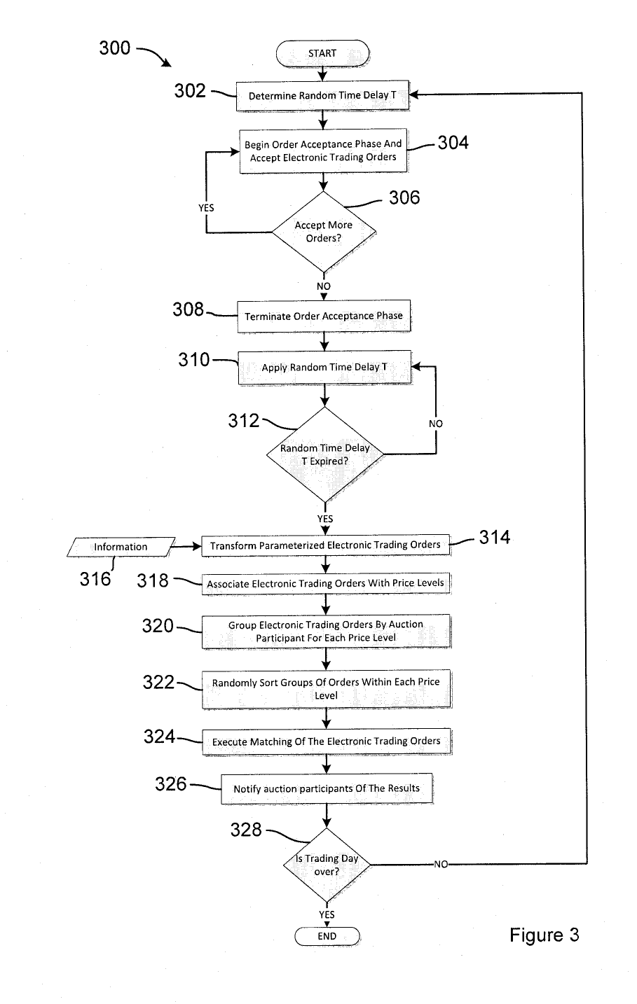

FIG. 3 is a flowchart of an exemplary order handling process that can be implemented by an exemplary embodiment of the engine 100. At step 302, the engine 100 can programmatically generate a random time delay to be applied subsequent to closing of an acceptance phase, and at step 304 the engine 100 can be programmed to begin the acceptance phase to accept electronic trading orders for the auction from auction participants. At step 306, the engine 100 can determine whether participants wish to enter more orders. For example, the engine 100 can programmatically generate a notification indicating that the acceptance phase of the auction will be closing to allow participants to submit their offers before the acceptance phase ends. If the engine 100 determines that the participants wish to enter more electronic trading orders and/or more electronic trading orders are submitted, the engine 100 continues at step 304 to programmatically accept more electronic trading orders from the auction participants. Otherwise, the engine 100 can be programmed to terminate the acceptance period at step 308 and to apply the random time delay at step 310 in response to the termination of the acceptance phase.

At step 312, the engine 100 waits for the random time delay to expire. After expiration of the random time delay, the engine 100 can be programmed to transform parameterized electronic trading orders into concrete electronic trading orders at step 314 based on information 316 ascertained by the engine 100. The information 316 can be time-dependent such that the time at which the information 316 is ascertained by the engine 100 can affect the content of the information. In some embodiments, the information 316 can be received, obtained, generated, determined, or otherwise ascertained contemporaneously with step 314 such that the information 316 used by the engine 100 can be ascertained by the engine 100 after the expiration of the random time delay. In some embodiments, the engine 100 can receive the information 316 after termination of the acceptance phase, but before the random time delay expires. As one example, the information 316 ascertained by the engine 100 can include the NBBO bid or ask prices and the parameterized electronic orders can be transformed to concrete orders using the NBBO bid or ask prices.

At step 318, the engine 100 can associate the price parameters of the electronic trading orders with price levels. In some embodiments, each unique, discrete value of the price parameters of the electronic trading orders can form a price level. For example, the electronic trading orders can specify values of fifteen dollars ($15.00), sixteen dollars ($16.00), and seventeen dollars ($17.00) for the price parameter and the engine 100 can use these values to define three price levels (e.g., one for each dollar amount). In this example, electronic trading orders having a value of fifteen dollars ($15.00) for the price parameters can form a first price level, electronic trading orders having a value of sixteen dollars ($16.00) can form second price level, and electronic trading orders having a value of seventeen dollars ($17.00) can form a third price level. In some embodiments, a price level can be formed of a range of price values such that a price level can include electronic trading orders having different values for the price parameter, but are within the specified range of the price level. For example, the price level can include values from fifteen dollars ($15.00) to seventeen dollars ($17.00) so that electronic trading orders specifying values of fifteen dollars ($15.00), sixteen dollars ($16.00), and seventeen dollars ($17.00) for the price parameter are associated with the same price level.

At step 320, the electronic trading orders in each price level can be grouped by auction participant to form groups of electronic trading orders within a price level for each auction participant having electronic trading orders with the applicable price level. At step 322, the engine 100 randomly sorts the groups of electronic trading orders within each price level to define price level order queues for each price level. The price level order queues generated by the random sort can each have a randomly generated sequence of grouped electronic trading orders. A relative position of the groups of electronic trading orders in the price level order queues can determine when the groups of electronic orders for each price level are processed by matching engine 130. For example, groups of electronic trading orders position toward the beginning of a price level order queue can be processed by the matching engine 130 before groups of electronic trading orders positioned towards the end of the price level order queue.

At step 324, the engine 100 can execute order matching based on the price levels and the randomized sorting of the groups of electronic trading orders. For example, the engine 100 can determine a clearing price for the financial instrument being auctioned and can identify price levels satisfying the clearing price. The groups of electronic trading orders in the price level order queues for the price levels satisfying the clearing price can be delivered to the matching engine 130 to match the electronic trading orders. In some embodiments, the matching engine 130 can use a price priority matching with intra-price priority to determine which price levels to process first and which electronic trading orders within the price level are matched first.

At step 326, the engine 100 can generate a notification to the participants of the auction including the results of the auction and at step 328, the engine determines whether to initiate another auction. If so, the engine 100 continues at step 302. Otherwise, the process ends.

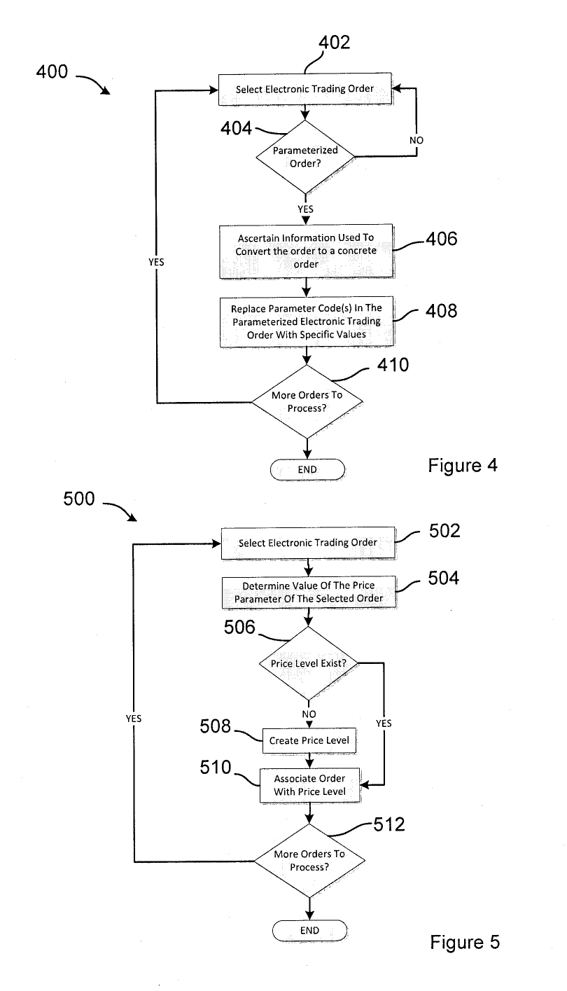

FIG. 4 is a flowchart of an exemplary order transformation process 400 implemented by embodiments of the exchange engine 100 for a parameterized order. To begin, the engine 100 selects an electronic trading order at step 402 and determines whether the electronic trading order is a parameterized order at step 404. For example, the engine 100 can identify parameter codes and/or processing instructions in the electronic trading order, and the engine 100 can programmatically identify the electronic trading order as a parameterized electronic trading order. If the engine determines that the electronic trading order is not a parameterized order, the engine 100 continues at step 402 to select another electronic trading order. If the engine 100 determines that the electronic trading order is a parameterized order, the engine 100 ascertains information to be used by the engine 100 to convert the parameterized order to a concrete order at step 406. As one example, the engine 100 can determine that the parameterized electronic trading orders specify that the price parameter should reflect the NBBO ask or bid price for the financial instrument (e.g., using a price code “NBBO Ask” or “NBBO Bid” for the price parameter). The information 314 ascertained by the engine 100 can include the NBBO ask or bid price for the financial instrument as of the time the engine 100 ascertains the information.

At step 408, the engine replaces parameter codes included in the parameterized electronic trading order with specific values based on the information ascertained by the engine 100 to convert the parameterized order to a concrete order (e.g., the engine replaces price code “NBBO Ask” or “NBBO Bid” with the ascertained NBBO ask or bid prices, respectively). At step 410, the engine 100 determines whether there are electronic trading orders that it has not processed. If there are more electronic trading orders to process, the engine continues at step 402 to select another electronic trading order to process. Otherwise, the order transformation process 400 ends. In one embodiment, although the processing happens sequentially, the external information used to process the parameterized orders into concrete orders can be the same set of information for all processing (e.g., it does not update the NBBO in between processing orders for the same auction cycle).

FIG. 5 is a flowchart of an exemplary process 500 implemented by embodiments of the exchange engine 100 to dynamically generate price levels and associate electronic trading orders with price levels. To begin, the engine 100 selects an electronic trading order at step 502 and determines a value of the price parameter of the electronic trading order at step 504. At step 506, the engine 100 determines whether a price level exists for the electronic trading order based on the value of the price parameter specified in the electronic trading order. If a price level exists, the engine associates the electronic trading order with the price level at step 508 and determines whether there are electronic trading orders that it has not processed at step 510. If there are more electronic trading orders to process, the engine 100 continues at step 502 to process another electronic trading order. Otherwise, the process 500 ends.

If a price level for the electronic trading order does not exist, the engine creates a price level for the electronic trading order based on the value of the price parameter specified by the electronic trading order at step 512 and associates the electronic trading order with the newly created price level at step 508. The engine 100 continues at step 506 to determine whether there are electronic trading orders that it has not processed. If there are more electronic trading orders to process, the engine 100 continues at step 502 to process another electronic trading order. Otherwise, the process 500 ends.

FIG. 6 is a flowchart showing an overview of one exemplary process 600 for the step of grouping electronic trading orders in FIG. 3. To begin, the engine 100 selects a price level at step 602 and selects an electronic trading order within the selected price level at step 604. At step 606, the engine 100 identifies an auction participant associated with the electronic trading order based on a participant identifier associated with the electronic trading order. At step 608, the engine 100 determines whether a group exists for the auction participant within the selected price level based on the participant identifier associated with the electronic trading order. If a group exists, the engine 100 associates the electronic trading order with the group at step 610 and determines whether there are electronic trading orders within the price level that it has not processed at step 612. If there are more electronic trading orders to process within the selected price level, the engine 100 continues at step 604 to process another electronic trading order. Otherwise, the engine determines whether there are more price levels to process at step 614. If there are more price levels to process, the engine continues at step 602 to select another price level. If there are no more price levels to process the process 600 ends.

If a group for the auction participant does not exist for the selected price level, the engine 100 creates a group based on the participant identifier associated with the electronic trading order at step 616. The engine 100 associates the electronic trading order with the newly created group at step 610 and determines whether there are electronic trading order that it has not processed at step 612. If there are more electronic trading orders to process within the selected price level, the engine 100 continues at step 604 to process another electronic trading order. Otherwise, the engine determines whether there are more price levels to process at step 614. If there are more price levels to process, the engine continues at step 602 to select another price level. If there are no more price levels to process the process 600 ends.

FIG. 7 is a flowchart of an exemplary embodiment of an electronic trading order sorting process 700 implemented by an exemplary embodiment of the exchange engine 100. To begin, the engine 100 selects a price level at step 702. At step 704, the engine 100 randomly sorts the groups or orders within the selected price level to generate a price level order queue having a randomly generated sequence of groups of electronic trading orders. A position of the groups in the price level order queue can determine a matching priority of the groups. At step 706, the engine 100 determines whether there are more price levels to process. If there are more price levels to process, the engine continues at step 702 to select another price level to process. If there are no more price levels to process the process 700 ends.

FIG. 8 is a diagram showing hardware and software components of an exemplary system 800 capable of performing the processes discussed above. The system 800 includes a processing server 802 (e.g., a computer), which can include a storage device 804, a network interface 808, a communications bus 816, a central processing unit (CPU) 810 (e.g., a microprocessor), a random access memory (RAM) 812, and one or more input devices 814 (e.g., a keyboard or a mouse). The processing server 802 can also include a display (e.g., a liquid crystal display (LCD) or a cathode ray tube (CRT)). The storage device 804 can include any suitable, computer-readable storage medium (e.g., a disk, non-volatile memory, read-only memory (ROM), erasable programmable ROM (EPROM), electrically-erasable programmable ROM (EEPROM) or flash memory). The processing server 802 can be, for example, a networked computer system, a personal computer, a smart phone, or a tablet.

The engine 100, or portions thereof, can be embodied as computer-readable program code stored on one or more non-transitory computer-readable storage devices 804 and can be executed by the CPU 810 using any suitable, high- or low-level computing language or platform, such as Java, C, C++, C#, and .NET. Execution of the computer-readable code by the CPU 810 can cause the engine 100 to implement embodiments of one or more processes. The network interface 808 can include, for example, an Ethernet network interface device, a wireless network interface device, or any other suitable device which permits the processing server 802 to communicate via the network. The CPU 810 can include any suitable single- or multiple-core microprocessor of any suitable architecture that is capable of implementing and/or running the engine 100 (e.g., an Intel processor). The random access memory 812 can include any suitable, high-speed, random access memory typical of most modern computers, such as dynamic RAM (DRAM).

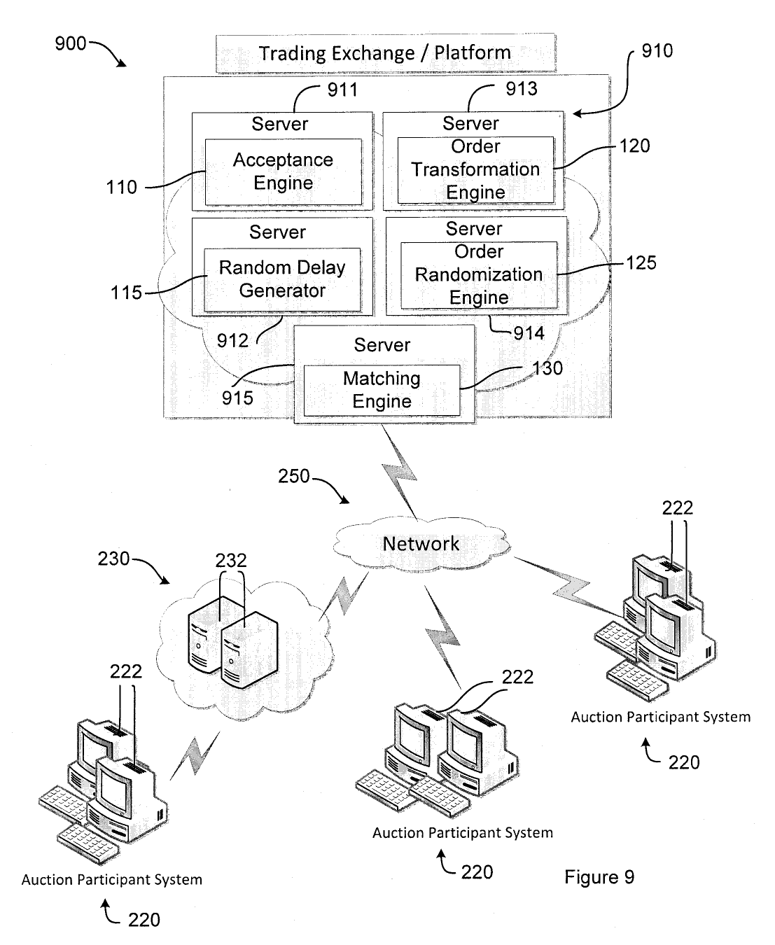

FIG. 9 is a block diagram of a distributed electronic trading exchange environment 900 in accordance with exemplary embodiments of the present disclosure. As shown in FIG. 9, an exemplary embodiment of the exchange engine 100 can be distributed across servers 911-915 associated with a trading exchange platform 910. For example, the server 911 can include acceptance engine 110, the server 912 can include the random period generator 115, the server 913 can include the order transformation engine 120, the server 914 can include the randomization engine 125, and the server 915 can include the matching engine 130. The servers 911-915 can be communicatively coupled to facilitate interaction between the servers 911-915 to implement one or more order handling processes of the engine 100. The electronic devices 222 associated with the auction participants' systems 220 can be communicatively coupled to the trading exchange platform 910 via the network 250 to facilitate an interaction between the auction participants' systems 220 and the trading exchange platform 910 as described herein. In some embodiments the auction participants' systems 220 can interface with the trading exchange platform through the intermediary system 230.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown therein.

1. A method of implementing an electronic trading exchange comprising:
accepting electronic trading orders from auction participants' electronic devices in a first time period of an electronic auction;
applying a random time delay in response to expiration of the first time period;
executing code to randomly sort the electronic trading orders to generate one or more order queues; and
programmatically matching the electronic trading orders based on a randomized sequence of electronic orders defined by the one or more order queues.

2. The method of claim 1, wherein executing code to randomly sort the electronic trading orders comprises:
programmatically grouping the electronic trading orders for a price level based on participant identifiers associated with the electronic trading orders within the price level subsequent to an expiration of a second time period; and
executing code to randomly sort the groups electronic trading orders within the price level to generate a price level order queue.

3. The method of claim 2, wherein programmatically matching the electronic trading orders comprises programmatically matching orders based on the price level and a randomized sequence of electronic orders defined by the price level order queue.

4. The method of claim 1, wherein accepting electronic trading orders comprises accepting parameterized orders having one or more order parameters to be determined subsequent to acceptance and concrete orders having parameters specified prior to acceptance.

5. The method of claim 4, further comprising executing code to transform the parameterized orders into concrete orders.

6. The method of claim 5, wherein executing code to transform the parameterized orders into concrete orders is performed based on information ascertained after the expiration of the second time period.

7. The method of claim 5, wherein executing code to transform the parameterized orders into concrete orders is performed prior to executing code to randomly sort the groups of electronic trading orders.

8. The method of claim 7, further comprising executing a subsequent auction after the auction ends, wherein the subsequent auction applies a different random time delay.

9. A non-transitory computer-readable medium storing instruction executable by a processing device in an electronic trading exchange environment, wherein execution of the instructions by the processing device causes processing of electronic trading orders in the electronic trading exchange environment, the processing comprising:
accepting electronic trading orders from auction participants' electronic devices in a first time period of an electronic auction;
applying a random time delay in response to expiration of the first time period;
executing code to randomly sort the electronic trading orders to generate one or more order queues; and
programmatically matching the electronic trading orders based on a randomized sequence of electronic orders defined by the one or more order queues.

10. The medium of claim 9, wherein executing code to randomly sort the electronic trading orders comprises:
programmatically grouping the electronic trading orders for a price level based on participant identifiers associated with the electronic trading orders within the price level subsequent to an expiration of a second time period; and
executing code to randomly sort the groups of electronic trading orders within the price level to generate a price level order queue.

11. The medium of claim 10, wherein programmatically matching the electronic trading orders comprises programmatically matching the electronic trading orders based on the price level and a randomized sequence of electronic trading orders defined by the price level order queue.

12. The medium of claim 9, wherein accepting electronic orders comprises accepting parameterized orders having one or more order parameters to be determined subsequent to acceptance and concrete orders having parameters specified prior to acceptance.

13. The medium of claim 12, wherein execution of the instructions causes the processing device to transform the parameterized orders into concrete orders.

14. The medium of claim 13, wherein executing code to transform the parameterized orders into concrete orders is performed based on information ascertained after the expiration of the second time period.

15. The medium of claim 13, wherein executing code to transform the parameterized orders into concrete orders is performed prior to executing code to randomly sort the groups of electronic orders.

16. The medium of claim 9, wherein the second time period is defined by a random time delay applied in response to a termination of the first time period.

17. The medium of claim 16, wherein execution of the instructions causes the processing device to execute a subsequent auction after the auction ends, the subsequent auction applying a different random time delay.

18. A system of processing electronic trading orders in an electronic trading exchange environment comprising:
at least one storage device storing instructions for an order handling process; and
a processing device communicatively coupled to the at least one storage device, the processing device being programmed to execute the instructions to:
accept electronic trading orders from auction participants' electronic devices in a first time period of an electronic auction;
apply a random time delay in response to expiration of the first time period;
execute code to randomly sort the electronic trading orders to generate one or more order queues; and
match the electronic trading orders based on a randomized sequence of electronic orders defined by the one or more order queues.

19. The system of claim 18, wherein executing code to randomly sort the electronic trading orders comprises:
programmatically grouping the electronic trading orders for a price level based on participant identifiers associated with the electronic trading orders within the price level subsequent to an expiration of a second time period; and
executing code to randomly sort the groups electronic trading orders within the price level to generate a price level order queue.

20. The system of claim 19, wherein programmatically matching the electronic trading orders comprises programmatically matching the electronic trading orders based on the price level and a randomized sequence of electronic trading orders defined by the price level order queue.

21. The system of claim 18, wherein accepting electronic orders comprises accepting parameterized orders having one or more order parameters to be determined subsequent to acceptance and concrete orders having parameters specified prior to acceptance.

22. The system of claim 21, further comprising executing code to transform the parameterized orders into concrete orders.

23. The system of claim 22, wherein executing code to transform the parameterized orders into concrete orders is performed based on information ascertained after the expiration of the second time period.

24. The system of claim 22, wherein executing code to transform the parameterized orders into concrete orders is performed prior to executing code to randomly sort the groups of electronic orders.

25. The system of claim 24, further comprising executing a subsequent auction after the auction ends, the subsequent auction applying a different random time delay.
